(19) United States
(12) Patent Application Publication
(10) Pub. No.: US 2018/0322439 A1
(43) Pub. Date: Nov. 8, 2018

(54) SYSTEMS AND METHODS FOR GENERATING ACTIVITIES ACROSS AN ENTERPRISE

(71) Applicant: ServiceNow, Inc., Santa Clara, CA (US)

(72) Inventors: Leena Dudani, Sunnyvale, CA (US); Lucinda Foss, San Francisco, CA (US); Ugur Ismail Sencan, San Diego, CA (US); Regis Cridlig, San Diego, CA (US); Alexander James Richberg, San Diego, CA (US)

(21) Appl. No.: 15/588,091

(22) Filed: May 5, 2017

(51) Int. Cl. G06Q 10/06; G06Q 10/10

(52) U.S. Cl. CPC G06Q 10/063114; G06Q 10/06316; G06Q 10/1097

(57) ABSTRACT

A system may include databases associated with a departments of an enterprise, such that the databases include data regarding a set of members of a respective department. The system may also include a processor that executes computer-executable instructions that cause the processor to receive a lifecycle event that corresponds with an employee of the enterprise, determine one or more activity sets based on the event. The activity sets may include a list of activities to be performed by one or more departments of the plurality of departments. The processor may then identify members of the set of members to perform the activities, and send updates to one or more respective databases of the plurality of databases regarding the progress of the activities. The processor may then generate a visualization to be depicted on a display, such that the visualization tracks a progress of the activities.

### TECHNICAL FIELD

The present disclosure relates in general to systems, methods, and apparatuses for identifying activities for individuals to perform across an enterprise. More specifically, the present disclosure is related to systems and methods for identifying activities for a fulfiller or an employee to perform based on an event related to a status of an individual or group of individuals associated with an enterprise.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

In an enterprise or organization, different operations may be performed by different departments (e.g., human resources, information technology). Generally, when a status (e.g., new hire, promotion) of a member (e.g., employee) within the enterprise changes, different departments may perform different activities to prepare the member for his updated status and new role within the enterprise. In some instances, one department may become aware of the status change via another department. Otherwise, each different department may independently initiate an activity for fulfillers and/or employees to perform without regard to the activities being performed by other departments. As each of the different departments becomes more interconnected with each other via shared computer resources hosted in distributed computing (e.g., cloud-computing) environments, it may be useful to coordinate the initiation and distribution of activities in a more efficient manner.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

As discussed above, different departments of an enterprise may be tasked with performing different operations based on an event or status change of a member of the enterprise. For example, an information technology (IT) department of an enterprise may be tasked (e.g., assigned activity) with assigning a newly hired employee with a computer, a facilities department may be tasked with assigning the newly hired employee a badge to grant access to certain buildings, a human resources department may be tasked with collecting certain information from the newly hired employee and the like. In certain embodiments, to assist in the assignment and distribution of activities across an enterprise, a server system may receive data indicative of a lifecycle event associated with a member of the enterprise. Based on the received data regarding the lifecycle event, the server system may determine one or more activity sets that detail one or more activities or tasks to be performed by various departments within the enterprise. The one or more activities may be assigned to certain individuals of certain departments of the enterprise. The activities may be pre-defined with respect to an activity set and stored on a database accessible to the server system. The activity sets may thus include activities that are to be performed, deadlines in which the activities are to be performed, and the like.

In addition to identifying the activity sets and corresponding activities, the server system may identify one or more fulfillers or employees of the enterprise to assign the activities. The server system may determine the activities and the fulfillers and/or employees based on data stored on a number of databases associated with the different departments of the enterprise. The data stored on the respective databases may include tables or the like that are organized with respect to life cycle events, activity sets associated with the life cycle events, fulfillers and/or employees associated with the activities, and the like. That is, the tables may include information related to fulfillers and/or employees that are familiar with certain activities associated with a particular activity set that is initiated in response to a detected or received life cycle event.

After identifying the fulfillers and/or employees (e.g., members of enterprise) to perform the activities, the server system may store data regarding respective activity sets that detail various activities assigned to a respective member in a database accessible to a number of computing devices. In one embodiment, a computing device associated with a respective member may retrieve or pull the data regarding respective activities assigned to the member from the database. The respective computing device may display the respective activities via a respective service portal user interface depicted on a display of the respective computing device. The service portal user interface may provide visualizations indicative of the respective activities assigned to the respective member, update the visualizations to provide indications regarded statuses of the respective activities, and the like. By employing the server system to identify activity sets based on different lifecycle events of an employee in an enterprise and identify members across an enterprise to perform various activities of the identified activity sets, the presently disclosed systems and techniques may more efficiently coordinate the initiation of activity sets and the distribution of activities to members across the enterprise. As such, a dynamic workflow may be executed by the server system to identify activity sets and members across the enterprise to perform the activities of the identified activity sets based on databases associated with different departments of the enterprise. In this way, an individual avoids generating scripts for each activity of an activity set assigned to each member for each received lifecycle event. As a result, the members associated with various activities are provided with information related to assigned activities in response to a lifecycle event across the enterprise, thereby allowing the employees of the enterprise to focus on activities that better serve the operation of the enterprise itself.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

The description herein makes reference to the accompanying drawings, wherein like reference numerals refer to like parts throughout the several views.

FIG. 1 is a block diagram of a generalized distributed computing system utilizing a cloud service, in accordance with an embodiment;

FIG. 2 is a block diagram of a computing device utilized in the distributed computing system of FIG. 1, in accordance with an embodiment;

FIG. 3 is a block diagram of an example server system that may be part of the distributed computing system of FIG. 1, in accordance with an embodiment;

FIG. 4 is a flow chart of a method for retrieving data related to activities associated with members of an enterprise using the example server system of FIG. 3, in accordance with an embodiment;

FIG. 5 is an example work flow of a method for retrieving data related to activities associated with members of an enterprise using the example server system of FIG. 3, in accordance with an embodiment;

FIG. 6 is an example graphical user interface displayed when retrieving data related to activities associated with members of an enterprise using the example server system of FIG. 3, in accordance with an embodiment;

FIG. 7 is an example graphical user interface displayed when retrieving data related to activities associated with members of an enterprise using the example server system of FIG. 3, in accordance with an embodiment;

FIG. 8 is an example graphical user interface displayed when retrieving data related to activities associated with members of an enterprise using the example server system of FIG. 3, in accordance with an embodiment;

FIG. 9 is an example graphical user interface displayed when retrieving data related to activities associated with members of an enterprise using the example server system of FIG. 3, in accordance with an embodiment;

FIG. 10 is an example graphical user interface displayed when retrieving data related to activities associated with members of an enterprise using the example server system of FIG. 3, in accordance with an embodiment;

FIG. 11 is an example graphical user interface displayed when retrieving data related to activities associated with members of an enterprise using the example server system of FIG. 3, in accordance with an embodiment;

FIG. 12 is an example graphical user interface displayed when retrieving data related to activities associated with members of an enterprise using the example server system of FIG. 3, in accordance with an embodiment;

FIG. 13 is an example graphical user interface displayed when retrieving data related to activities associated with members of an enterprise using the example server system of FIG. 3, in accordance with an embodiment;

FIG. 14 is an example graphical user interface displayed when retrieving data related to activities associated with members of an enterprise using the example server system of FIG. 3, in accordance with an embodiment;

FIG. 15 is an example graphical user interface displayed when retrieving data related to activities associated with members of an enterprise using the example server system of FIG. 3, in accordance with an embodiment;

FIG. 16 is an example graphical user interface displayed when retrieving data related to activities associated with members of an enterprise using the example server system of FIG. 3, in accordance with an embodiment; and

FIG. 17 is an example flow diagram for pushing targeted content data to a subset of members of an enterprise, in accordance with an embodiment.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Information Technology (IT) devices are increasingly important in an increasingly electronics-driven world in which various electronics devices are interconnected within a distributed context. As more functions are performed by services using some form of distributed computing, the ability of IT devices to coordinate activities for different members across an enterprise increases. That is, different departments of an enterprise may be located in different places and may operate independent of each other. However, employing certain IT devices, such as a server system that is communicatively coupled to databases related to the different departments, may allow the implementation of dynamic workflows that send different sets of instructions to different user interfaces of different members based on a change in the status of one member of the enterprise. That is, after receiving an indication that a role of a member of an enterprise is changing or a new member is being added to the enterprise, the server system may dynamically determine different activity sets that detail different activities for different members to perform for different departments based on the information available on the databases associated with the different departments and the indication. Each activity set may be a container that lists a number of activities that may be performed in response to the life cycle event. However, it should be noted that each activity listed as part of the activity set may not be assigned or initiated depending on whether the member associated with the lifecycle event matches certain criteria that specifies when a respective activity will be assigned to a respective fulfiller or employee. After determining the activity sets associated with the role change, determining which activities of the activity set have criteria that match properties (e.g., location, job title) of the member associated with the lifecycle event, and identifying the members to task to perform the identified activities, the server system may store the identified activities for the members in a central database that may be accessible to computing devices or accounts associated with the identified members.

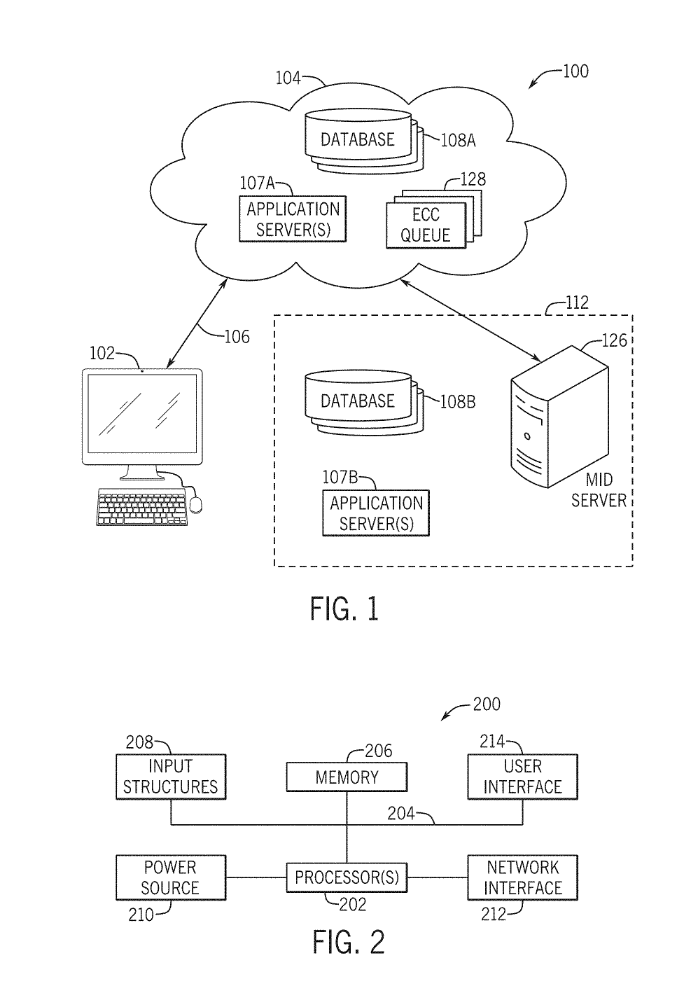

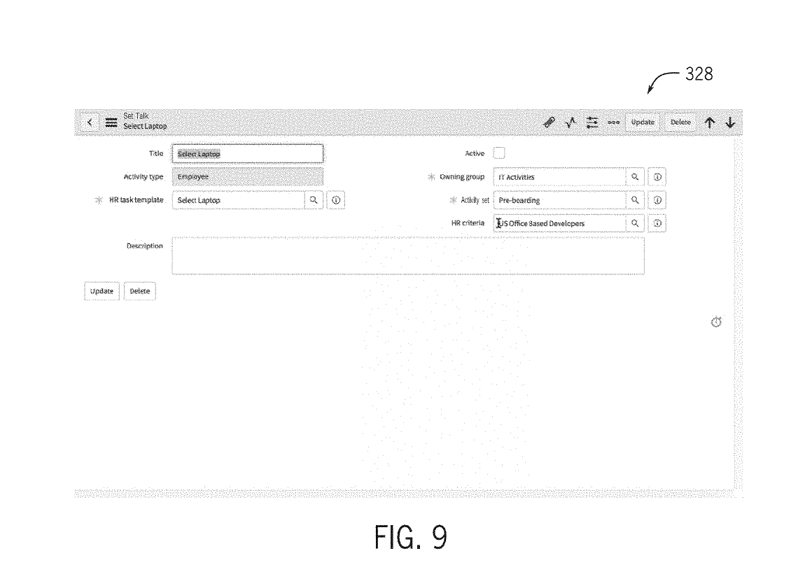

Each respective computing device or account may retrieve the respective activities of an identified activity set assigned to the respective member when the respective computing device or account communicates with the server system. In some embodiments, each respective computing device may retrieve the respective activities and update a respective user interface to indicate that the activities assigned to the respective member. The respective computing device may also track the progress of completion of each of the activities of the activity set and send updates with regard to the progress to the server system for storage and access to other members of the enterprise. By identifying activities to be performed based on a lifecycle event of a member and based on whether certain properties of the member correspond with certain criteria involved with certain activities of the activity set, the server system may provide a personalized workflow that caters to the various properties of the individual member using one dynamic workflow. Additional details with regard to the embodiments described herein will be discussed below with reference to FIGS. 1-17.

By way of introduction FIG. 1 is a block diagram of a system 100 that utilizes a distributed computing framework, which may perform one or more of the techniques described herein. As illustrated in FIG. 1, a client 102 communicates with a cloud service 104 over a communication channel 106. The client 102 may include any suitable computing system. For instance, the client 102 may include one or more computing devices, such as a mobile phone, a tablet computer, a laptop computer, a notebook computer, a desktop computer, or any other suitable computing device or combination of computing devices. The client 102 may include client application programs running on the computing devices. The client 102 can be implemented using a single physical unit or a combination of physical units (e.g., distributed computing) running one or more client application programs. Furthermore, in some embodiments, a single physical unit (e.g., server) may run multiple client application programs simultaneously.

The cloud service 104 may include any suitable number of computing devices (e.g., computers) in one or more locations that are connected together using one or more networks. For instance, the cloud service 104 may include various computers acting as servers in datacenters at one or more geographic locations where the computers communicate using network and/or Internet connections. The communication channel 106 may include any suitable communication mechanism for electronic communication between the client 102 and the cloud service 104. The communication channel 106 may incorporate local area networks (LANs), wide area networks (WANs), virtual private networks (VPNs), cellular networks (e.g., long term evolution networks), and/or other network types for transferring data between the client 102 and the cloud service 104. For example, the communication channel 106 may include an Internet connection when the client 102 is not on a local network common with the cloud service 104. Additionally or alternatively, the communication channel 106 may include network connection sections when the client and the cloud service 104 are on different networks or entirely using network connections when the client 102 and the cloud service 104 share a common network. Although only a single client 102 is shown connected to the cloud service 104, it should be noted that cloud service 104 may connect to multiple clients (e.g., tens, hundreds, or thousands of clients).

Through the cloud service 104, the client 102 may connect to various devices with various functionality, such as gateways, routers, load balancers, databases, application servers running application programs on one or more nodes, or other devices that may be accessed via the cloud service 104. For example, the client 102 may connect to an application server 107A and/or one or more databases 108A via the cloud service 104. The application server 107A may include any computing system, such as a desktop computer, laptop computer, server computer, and/or any other computing device capable of providing functionality from an application program to the client 102. The application server 107A may include one or more application nodes running application programs whose functionality is provided to the client via the cloud service 104. The application nodes may be implemented using processing threads, virtual machine instantiations, or other computing features of the application server 107A. Moreover, the application nodes may store, evaluate, or retrieve data from the databases 108A and/or a database server.

The databases 108A may contain a series of tables containing information about assets and services controlled by a client 102 and the configurations of these assets and services. The assets and services include may include hardware resources (such as server computing devices, client computing devices, processors, memory, storage devices, networking devices, or power supplies); software resources (such as instructions executable by the hardware resources including application software or firmware); virtual resources (such as virtual machines or virtual storage devices); and/or storage constructs (such as data files, data directories, or storage models).

In some embodiments, the databases 108A, whether in the cloud or at a client site accessible via the cloud or other network interconnection, may include information related to activity sets for certain personnel to perform. The databases 108A may each be associated with one or more departments of an enterprise. That is, an enterprise or organization may include a number of different departments that perform different operations for the overall enterprise. For instance, an IT department may assist in connecting information technology (IT) devices, software or applications, or virtualized environments for a member (e.g., employee) of the enterprise, human resources department may assist in hiring the member, and a facilities department may assist in providing access to various building associated with the member.

In addition to the databases 108A, the cloud service 104 may include one or more other database servers. The database servers are configured to store, manage, or otherwise provide data for delivering services to the client 102 over the communication channel 106. The database server may include one or more additional databases that are accessible by the application server 107A, the client 102, and/or other devices external to the additional databases. By way of example, the additional databases may include information related to member or assets of the enterprise. In some embodiments, the information regarding each member may be organized or stored a respective database of the databases 108A based on a department in which the member is assigned to. The information may include data regarding the member such as skill set, education background, role, job function, assigned activities or tasks, location, demographic information, and the like.

In the depicted topology, access to non-cloud resources, such as database 108B and/or application server 107B, from the cloud service 104 is enabled via a management, instrumentation, and discovery (MID) server 126 via an External Communications Channel (ECC) Queue 128. The MID server 126 may include an application program (e.g., Java application) that runs as a service (e.g., Windows service or UNIX daemon) that facilitates communication and movement of data between the cloud service 104 and external applications, data sources, and/or services. The MID service 126 may be executed using a computing device (e.g., server or computer) on the network 112 that communicates with the cloud service 104.

The ECC queue 128 may be a database table that is typically queried, updated, and inserted into by other systems. Each record in the ECC queue 128 is a message from an instance in the cloud service 104 to a system (e.g., MID server 126) external to the cloud service 104 that connects to the cloud service 104 or a specific instance running in the cloud service 104 or a message to the instance from the external system. The fields of an ECC queue 128 record include various data about the external system or the message in the record.

Although the system 100 is described as having the application servers 107A, the databases 108A, the ECC queue 128, the MID server 126, and the like, it should be noted that the embodiments disclosed herein are not limited to the components described as being part of the system 100. Indeed, the components depicted in FIG. 1 are merely provided as example components and the system 100 should not be limited to the components described herein. Instead, it should be noted that other types of server systems may communicate with the cloud service 104 in addition to the MID server 126.

Further, it should be noted that server systems described herein may communicate with each other via a number of suitable communication protocols, such as via wired communication networks, wireless communication networks, and the like. In the same manner, the client 102 may communicate with a number of server systems via a suitable communication network without interfacing its communication via the cloud service 104.

In addition, methods for populating the databases 108A may include directly importing data or entries from an external source, manual import by users entering or updating data entries via a user interface, and the like. Moreover, it should be understood that the embodiments described herein should not be limited to being performed with respect to a particular database or type of stored data. Instead, the present systems and techniques described herein may be implemented with any suitable database.

In any case, to perform one or more of the operations described herein, the client 102, the application server 107A, the MID server 126, and other server or computing system described herein may include one or more of the computer components depicted in FIG. 2. FIG. 2 generally illustrates a block diagram of example components of a computing device 200 and their potential interconnections or communication paths, such as along one or more busses. As briefly mentioned above, the computing device 200 may be an embodiment of the client 102, the application server 107A, a database server (e.g., databases 108A), other servers or processor-based hardware devices present in the cloud service 104 (e.g., server hosting the ECC queue 128) or at a local or remote client site, a device running the MID server 126, and so forth. As previously noted, these devices may include a computing system that includes multiple computing devices and/or a single computing device, such as a mobile phone, a tablet computer, a laptop computer, a notebook computer, a desktop computer, a server computer, and/or other suitable computing devices.

As illustrated, the computing device 200 may include various hardware components. For example, the device includes one or more processors 202, one or more busses 204, memory 206, input structures 208, a power source 210, a network interface 212, a user interface 214, and/or other computer components useful in performing the functions described herein.

The one or more processors 202 may include processor capable of performing instructions stored in the memory 206. For example, the one or more processors may include microprocessors, system on a chips (SoCs), or any other performing functions by executing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206. Moreover, the functions of the one or more processors 202 may be distributed across multiple processors in a single physical device or in multiple processors in more than one physical device. The one or more processors 202 may also include specialized processors, such as a graphics-processing unit (GPU).

The one or more busses 204 include suitable electrical channels to provide data and/or power between the various components of the computing device. For example, the one or more busses 204 may include a power bus from the power source 210 to the various components of the computing device. Additionally, in some embodiments, the one or more busses 204 may include a dedicated bus among the one or more processors 202 and/or the memory 206.

The memory 206 may include any tangible, non-transitory, and computer-readable storage media. For example, the memory 206 may include volatile memory, non-volatile memory, or any combination thereof. For instance, the memory 206 may include read-only memory (ROM), randomly accessible memory (RAM), disk drives, solid state drives, external flash memory, or any combination thereof Although shown as a single block in FIG. 2, the memory 206 can be implemented using multiple physical units in one or more physical locations. The one or more processor 202 accesses data in the memory 206 via the one or more busses 204.

The input structures 208 provide structures to input data and/or commands to the one or more processor 202. For example, the input structures 208 include a positional input device, such as a mouse, touchpad, touchscreen, and/or the like. The input structures 208 may also include a manual input, such as a keyboard and the like. These input structures 208 may be used to input data and/or commands to the one or more processors 202 via the one or more busses 204. The input structures 208 may alternative or additionally include other input devices. For example, the input structures 208 may include sensors or detectors that monitor the computing device 200 or an environment around the computing device 200. For example, a computing device 200 can contain a geospatial device, such as a global positioning system (GPS) location unit. The input structures 208 may also monitor operating conditions (e.g., temperatures) of various components of the computing device 200, such as the one or more processors 202.

The power source 210 can be any suitable source for power of the various components of the computing device 200. For example, the power source 210 may include line power and/or a battery source to provide power to the various components of the computing device 200 via the one or more busses 204.

The network interface 212 is also coupled to the processor 202 via the one or more busses 204. The network interface 212 includes one or more transceivers capable of communicating with other devices over one or more networks (e.g., the communication channel 106). The network interface may provide a wired network interface, such as Ethernet, or a wireless network interface, such an 802.11, Bluetooth, cellular (e.g., LTE), or other wireless connections. Moreover, the computing device 200 may communicate with other devices via the network interface 212 using one or more network protocols, such as Transmission Control Protocol/Internet Protocol (TCP/IP), power line communication (PLC), Wi-Fi, infrared, and/or other suitable protocols.

A user interface 214 may include a display that is configured to display images transferred to it from the one or more processors 202. The display may include a liquid crystal display (LCD), a cathode-ray tube (CRT), a light emitting diode (LED) display, an organic light emitting diode display (OLED), or other suitable display. In addition and/or alternative to the display, the user interface 214 may include other devices for interfacing with a user. For example, the user interface 214 may include lights (e.g., LEDs), speakers, and the like.

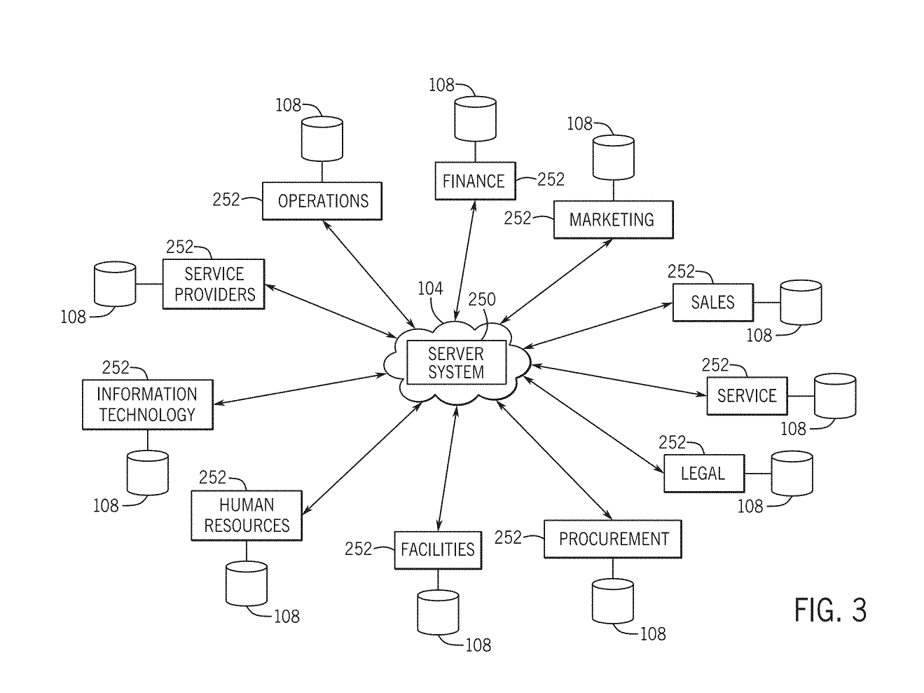

With the foregoing in mind, FIG. 3 illustrates a block diagram of an example server system 300 that may be communicatively coupled to different department server systems via the cloud service 104. As mentioned above, an enterprise or organization may be made up of a number of different departments. In one embodiment, server system 250 may be a computing device 200 or the like accessible to the cloud service 104. The server system 250 may access different databases 108 associated with different departments. Each database 108 associated with a respective department may communicate with the server system 250 via the cloud service 104 and a respective server system associated with the respective database. For example, FIG. 3 illustrates a number of server systems that may facilitate communication to, query requests, and the like with a respective database 108.

By way of example, the department server systems 252 may be associated with departments such as an operations department, a finance department, a marketing department, a sales department, a service department, a legal department, a procurement department, a facilities department, a human resources department, an information technology department, a service providers department, and the like. Generally, a database 108 associated with each department may include data related to the members of the enterprise that are also part of the respective department, tasks or activities to be performed by the department, calendar information related to the events scheduled for the respective department, and the like. In one embodiment, the data related to the members of the department may include a working schedule of the member, a list of skills of the member, a list of job functions performed by the member, and the like. The activities stored in a respective database associated with a respective department may include a list of tasks to be performed by a member of the respective department in response to a certain event (e.g., lifecycle event) and an association to an activity set related to the event. The event may be related to a change in a status of a member of the enterprise. For instance, the event may be related to employee on-boarding, employee off-boarding, employee location change, employee organization change, employee promotion, and the like.

Employee on-boarding may include instances when a new member (e.g., employee) joins the enterprise. Conversely, employee off-boarding may include when a member terminates his association with the enterprise. Employee location change may refer to when a member moves locations within the enterprise. The location change may include a change in office space with respect to one office building or with respect to a different geographical location (e.g., city, state, country). Employee organization change may include changing the department in which the member is associated with. In addition, employee promotion may include instances when a job title of a member changes, and thus responsibilities or job functions of the member changes.

Referring briefly back to FIG. 3, each of the illustrated departments may perform different functions that contribute to the operation of the enterprise as a whole. For example, the finance department may be tasked with generating financial reports and financial forecasts for the enterprise. The marketing department may be tasked with generating marketing documents and strategies for the enterprise, products produces by the enterprise, and the like. The sales department may be tasked with coordinating sales effort to engage new business relationships for the enterprise. The service department may coordinate with existing clients of the enterprise to maintain products and services previously sold to the clients. The legal department may be tasked with ensuring that the enterprise conforms to the laws of the jurisdictions in which the enterprise operates. The procurement department may manage the distribution of supplies, products, and services to and from the enterprise. The facilities department may control access to different building owned and operated by the enterprise. The facilities department may also control the environmental conditions of each building and the maintenance operations for maintaining building structure and operations. In addition, the human resources department may manage the employment services provided to a member of the enterprise. For example, the human resources department may collect information regarding a new hire, coordinate benefits services provided to the new hire, and the like. The information technology (IT) department may manage the devices (e.g., printer, databases, server systems, computing devices) used by the member for the enterprise. The service providers department may coordinate with vendors and other organization that provide services to the enterprise. It should be noted that the foregoing list of departments should not be construed as an exclusive list of departments or a defined list of operations performed by the department; instead, the description of the departments are provided as examples and may include additional departments and additional operations and tasks for the described departments.

Given the number of different departments associated with a single enterprise, it may prove to be difficult to coordinate activities across the enterprise. For example, during an employee on-boarding event, a number of departments may have activities or tasks to perform to enable the new hire to perform his/her job functions more quickly and efficiently. Keeping this example in mind, before the new hire starts, the IT department may identify a computing device for the new member to use, add the new member to a database for access to the server system 250 or other computing resources, issue network user name for the new member, and the like. In the same manner, the HR department may prepare documents for the new member to review and sign upon starting his/her employment. The facilities department assign a workspace to the individual and may prepare a badge or other identification material for the new member to gain access to certain buildings based on the department that the new member will be joining, the job functions of the new member, and the like.

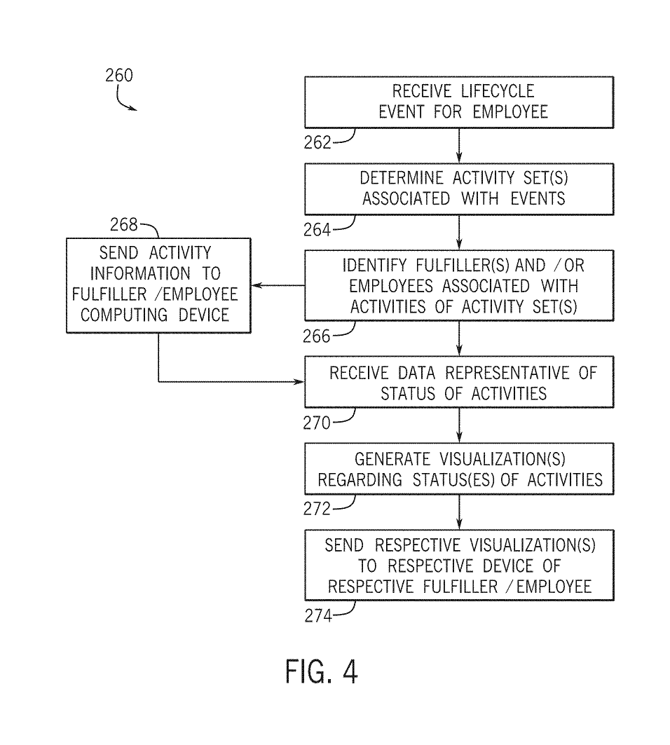

As shown in the example above, different departments may have different activities or tasks that are to be performed based on a given event associated with a member of the enterprise. To better coordinate the distribution and tracking of the progress of the activities for each department of the enterprise, the server system 250 may communicate with department server systems 252 and respective databases 108 to identify respective activities for certain members of the respective departments to perform based on an identified activity set associated with a lifecycle event for a member. FIG. 4, for instance, illustrates a flow chart of a method 260 for coordinating the assignments of activities detailed in activity sets for members across an enterprise based on a detected lifecycle event.

Although the following description of the method 260 is detailed in a particular order, it should be noted that the method 260 may be performed in any suitable order. Moreover, although the method 260 is described as being performed by the server system 250, it should be understood that the method 260 may be performed by any suitable computing device, as described above.

Referring now to FIG. 4, at block 262, the server system 250 may receive an indication or detect that a lifecycle event for a member of the enterprise has occurred. The lifecycle event may refer to a change in the status of the member within the enterprise. The status of the member may be related to the member's title, location, job function, tasks, position within a hierarchy of the enterprise, or the like. In certain embodiments, the server system 250 may detect the lifecycle event based on a comparison between data regarding a member at a previous time and at a current time. In other embodiments, the server system 250 may detect the lifecycle event based a newly made association between certain information (e.g., location, title, supervisor, department) regarding a member and the member himself.

Additionally, triggers for causing the server system 250 to detect the lifecycle event may be pre-defined by a user of the server system 250. That is, a user may provide an indication as to what constitutes a lifecycle event. In this way, a user may indicate to the server system 250 that when certain changes are applied to certain aspects of a profile of a member, these changes correspond to a lifecycle event.

After detecting or receiving an indication of the lifecycle event, at block 264, the server system 250 may determine one or more activity sets associated with the lifecycle event. Activity sets may each include a number of activities to be performed by members of an enterprise. As such, the activity set may be a container object that includes information related to one or more activities to be performed for a particular hierarchical operation. Each activity set may correspond to a certain procedure that is to be performed in response to the respective event. For instance, a detected lifecycle event may include employee on-boarding, as discussed above. Activity sets associated with employee on-boarding may include a pre-hire activity set, a pre-boarding activity set, and a first day activity set. Each of these activity sets may include certain activities to be performed for the associated grouping. For example, the pre-hire activity set may include a background check activity and/or a drug screening activity. The pre-boarding activity set may include activities, such as completing 1-9 form, selecting equipment, setup office, and the like. The first day activity set may include activities like creating a user profile for access to a network, setting up payroll, as so forth.

To identify the activity sets associated with the detected event, the server system 250 may query the department server systems 252 to search for activity sets associated with the detected lifecycle event. For instance, in the example of a new hire, the server system 250 may query the department server system 252 that corresponds to the IT department to identify activities or tasks that the IT department should perform to enable the new hire to perform his or her job functions. These activities or tasks may correspond to an activity set. In some embodiments, in response to detecting the lifecycle event, the server system 250 may access a database 108 that includes a number of activity sets, each of which may be organized according to a respective lifecycle event. After identifying the activity set associated with the respective event, the server system 250 may determine the activities to be performed by various member of different departments in the enterprise. That is, each activity of an activity set may include a set of criteria or the like that specifies when the respective activity will be assigned to a fulfiller, employee, or the like. In this way, the set of criteria of a respective activity set indicates when the respective activity is to be performed based on whether the properties of the member having the lifecycle event meets the set criteria. Each activity set may include any suitable number of activities, but it should be noted that the server system 250 will assign or initiate activities of a respective activity set based on whether the set of criteria associated with the respective activity is present. By way of example, a pre-hire activity set may include an activity that includes receiving work permit information. This activity may have a criteria or condition that indicates that the respective activity applies to those members that are not U.S. citizens. As such, the activity will not be initiated or assigned for members that are U.S. citizens.

The activities and information (e.g., criteria) associated with the activities for different activity sets may be stored in respective databases 108 via tables or the like. The tables may be organized with respect to different lifecycle events (e.g., on-boarding, off-boarding, location change, promotion) and respective activity sets associated with the respective lifecycle event. Since the server system 250 is communicatively coupled to the department server systems 252, or, in some embodiments, to the databases 108 associated with the different departments, the server system 250 may determine activities to be performed across the enterprise. In other words, the server system 250 may coordinate the identification and assignment of activities for each department of the enterprise.

In addition, the server system 250 may coordinate the initiation of certain activities in response to the completion of other activities. That is, upon receiving an indication that certain activity associated with an activity set is completed, other activities of the respective activity set for a different department may be now be performed. These activities may involve an ordered process that operates in a particular order or where certain activities may use information determined using a different activity to begin. In some cases, the indication that a certain activity has been completed may be defined as a criterion for another activity to be performed. By way of example, the IT department may be tasked with setting up a computing device for a new hire but may not be able to perform the task until the facilities department identifies an available office space for the new hire. In this example, the server system 250 may await for confirmation that the new hire is assigned a desk space before engaging the IT department with an activity set for setting up the computing device at the assigned desk space.

In addition to receiving an indication of the lifecycle event, activity sets may include trigger data that specifies when the server system 250 is to initiate an activity set and assign activities to be performed. For example, the trigger data may specify that certain activities or an activity set is to be initiated based on an availability of a member associated with certain activity sets, rules that detail when (e.g., two weeks before a scheduled start date) a life cycle event has been detected, new equipment discovered within the network by automated probe routines, and the like. As discussed briefly above, the trigger data may also indicate whether the completion of other activities may trigger or cause the server system 250 to detect the lifecycle event or a situation that involves the server system 250 determining other activities to assign.

In any case, after the activity sets and activities to be performed are identified, at block 266, the server system 250 may identify members (e.g., fulfillers and/or employees associated with the event) associated with the identified activities detailed in the identified activity sets. The identified members may include one or more members of a department that may have job junctions that include performing one or more of the tasks included in the activity sets. In addition, the identified members may include an employee that the lifecycle event is directed towards. That is, the members assigned to various activities of an activity set may include fulfillers that are tasked with performing certain tasks to prepare the employee for the status change and the employee, himself, who may be tasked with providing information to different fulfillers. In addition, it should be noted that the assigned member may include any employee of the enterprise. The information (e.g., name, location, schedule) of members to assign to activities may be stored in the database 108 with respect to activity sets via tables or the like.

In addition to identifying the members, the server system 250 may determine trigger data associated with the activities of the activity sets. That is, certain activities may be associated with date triggers that depend on certain instances. For example, upon receiving an indication regarding when a new member will start employment, the server system 250 may identify a respective activity set associated with the new employment, determine the activities associated with the respective activity set, identify a subset of activities in which the lifecycle event or member associated with the lifecycle event meets a respective set of criteria, and determine one or more dates for various activities to be performed, as detailed in the respective activity set associated with the new employment. For instance, the IT department may be assigned an activity for issuing a computing device for the new hire one week prior to the start date. In some embodiments, the trigger data may be specified with respect to the activity in metadata, by the creator of the activity, or the like. However, in other embodiments, the server system 250 may identify common trends that a certain department may use when assigning trigger data to respective activities, that particular members use when creating certain activities, and the like. For example, if a particular member assigns an activity to a certain department more than two times, and the particular member specifies the same trigger data for the same activity each time, the server system 250 may automatically populate the trigger data for similarly created activities to include the same trigger data.

In some embodiments, the trigger data may be defined when the activity of the activity set is created by a user via a graphical user interface, input device, or the like. The trigger data may include a time input that indicates when an activity should be initiated and/or completed. As mentioned above, each activity may have a set of criteria (e.g., human resources criteria) associated therewith that specifies to the server system 250 which activities of an activity set are to be initiated or assigned. After identifying the activities that are to be performed, the server system may identify a subset of the members of the enterprise to which the respective activity should be assigned. That is, the activity may be associated with some criteria that indicates that the activity may be assigned to members who work at a particular location, within a certain department, has a certain skill set, has a particular job title, and the like. In this way, the set of criteria associated with the respective activities may assist the server system 250 in identifying the appropriate members to perform the respective activities. For example, an activity that corresponds to a new hire signing up for a 401k plan applies to members that are located in the U.S. and does not apply to any other member who are located outside of the U.S. As such, the criteria for the 401k plan activity may include a location parameter indicating that the activity should be performed for U.S. located members. With this in mind, it should be noted that the corresponding activity set may include activities for similar replacement benefits available in other countries but these activities may not be initiated due to the target member not having the appropriate criteria. As a result, certain activities of a respective activity set may apply to certain members and may not apply to all members. However, since the activity set may be programmed to include any suitable number of activities and yet the server system 250 may filter through the activities to perform just those that apply to a certain situation or member, the server system 250 is capable of personalizing an activity set workflow for each member while retaining the flexibility to perform a number of different workflows for different members and under different circumstances.

At block 268, the server system 250 may generate a list of assigned activities determined at block 266 for each of the identified member of block 266. In one embodiment, the server system 250 may store the assigned activities along with the associated fulfillers in a database 108 accessible to a number of computing devices via a communication protocol. As such, the computing device of a member may access the server system 250 or the database 108 that the server system 250 stores the activities and retrieve information regarding activities assigned to the respective member. In this way, the computing device of the member may pull data from the respective database 108 or via the server system 250 in response to accessing the server system 250, accessing a user interface associated with the member and the enterprise, or the like.

In some embodiments, the computing device may access a user interface associated with the respective identified member via the cloud service 104. The server system 250 may generate a user interface that indicates a list of activities assigned to the respective member. In addition, the server system 250 may generate a visualization that lists the assigned activities, indicates a progress or status of the assigned activities, or the like. When the computing device accesses the cloud service 104 or the server system 250, the computing device may retrieve the list of activities, the generated visualizations, and other pertinent information provided via the server system 250 and display the retrieved information via a corresponding display device.

As the member completes tasks, information regarding the completed activity may be updated via the user interface. The updated information may be received, at block 270, by the server system 250 as status updates for the activities. In one embodiment, the member inputs updates to the status of the activities after each respective activity is completed. In another embodiment, the server system 50 may detect that an activity of the activity set is completed when a certain data field or entry in the database 108 is updated. For instance, if the activity includes issuing a computing device to a newly hired employee, when the member inputs data indicative of an assignment of a computing device to the corresponding member into a respective database 108, the server system 250 may automatically update the respective status of the associated activity. The updated status may then be retrieved by the computing device of the member via the server system 250.

At block 272, the server system 250 may generate one or more visualizations related to the status of the activities based on the data received at block 270. The visualizations may include information detailing a progress bar indicating steps completed, percentage completed, items left, and the like. As mentioned above, the visualizations may be accessed by the computing device via the server system 250. In one embodiment, the server system 250 may build a custom user interface for each member of the enterprise to access. The user interface may receive data pushed from sources (e.g., databases 108) that specifies a specific member, a group of members, a subset of members that are identified using filters, and the like. In one example, the visualizations may be provided to a respective user interface associated with the member who initiated the lifecycle event. Additional detail with regard to the user interface will be described below.

In addition to the activities assigned to a particular member, the system server 250 may also generate visualizations indicative of statuses and data related to other activities associated with other members. The other members may include members of the enterprise that are supervised or managed by the particular member. As such, the managing member may track the progress of a number of activities associated with subordinate members. With this in mind, certain visualizations may include tabs to access information related to activity sets for the particular member associated with the accessing computing device and for the members managed by the particular member, information related to activity sets for the members managed by the particular member, information related to the activity sets for the particular member alone, and the like.

In addition, the server system 250 may provide organization features for the user interface to enable the particular member to view items that are to be performed and items that have been completed. The items may also be organized with respect to due dates. The visualization may organize the activity set with respect to time in a calendar, timeline, or the like.

In some embodiments, the visualizations depicted in the user interface may be accessed or may be a configurable input that may be coupled to a document that may be a form or part of a task that is specified to be performed. When accessing a document that may be a form, the server system 250 may parse fields of a document (e.g., Portable Document Format) that may not be altered electronically. In one embodiment, the server system 250 may parse the document to identify key words (e.g., signature) that may denote places within the document where input is requested. After identifying fields within the document that may expect to receive input from the member, the server system 250 may map the places within the document to the user interface display depicting the document. The mapped regions may move with the document as the document is scrolled in and out of view via the display. The server system 250 may enable the member to access the mapped portions of the user interface display to add information via an input device (e.g., keyboard, mouse, electronic pen). For example, the member may sign the document via the mapped portions of the user interface display. The server system 250 may then merge the mapped portion of the user interface display and the associated document to generate an updated document with the input information. The resulting document may then be stored in an appropriate database 108A or the like, and the server system 250 may update a corresponding status of the activity set or task associated with the document accordingly.

Although FIG. 4 illustrates a flowchart of the method 260 related to identifying activities of activity sets, it should be noted that in some embodiments a member may initiate or open a case that includes one or more activities without being invoked by the detection or reception of the lifecycle event. That is, a creator member may specify to the server system 250 to create a case and define one or more activities associated with that case. The server system 250 may, in response to receiving the case, identify members to complete the activities specified by the case, as described above. In some embodiments, the case may be associated with an activity set that specifies certain activities to be performed.

Referring back to FIG. 4, after generating the visualizations, at block 274, the server system 250 may send the respective visualizations or respective user interfaces to respective computing devices. As such, each member of the enterprise may view assigned tasks and provide updated statuses to the server system 250, which provides visibility to members across the enterprise.

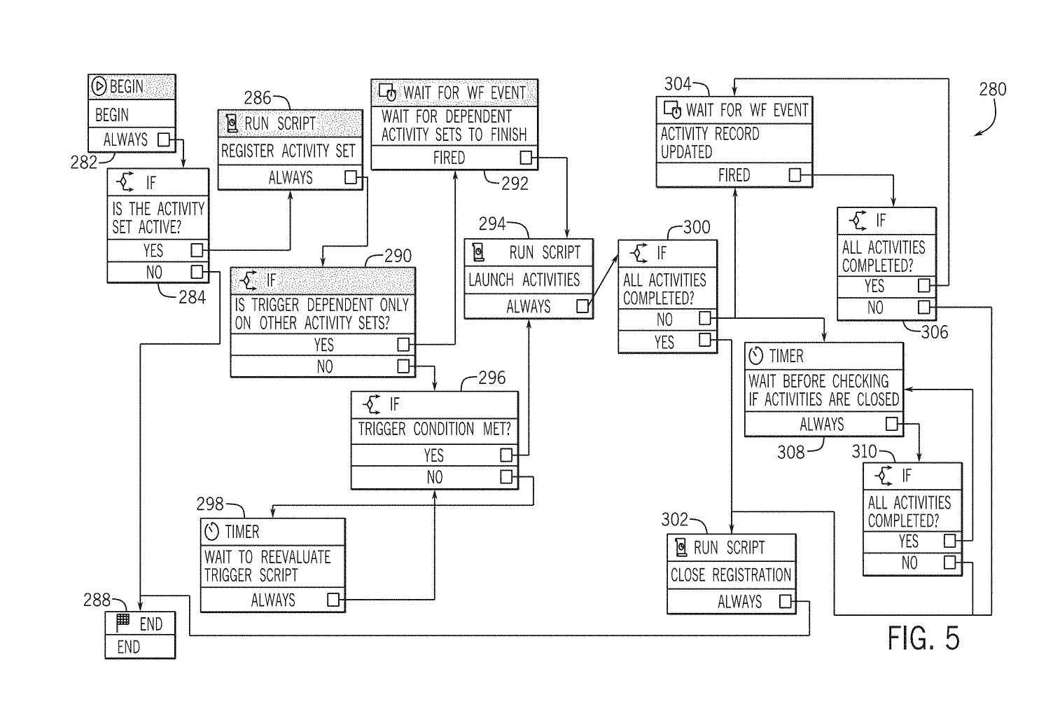

With the foregoing in mind, FIG. 5 illustrates a workflow 280 of a process that the server system 250 may employ when generating activity sets for members of the enterprise. Although the following description of the workflow 280 is described as being performed by the server system 250, it should be noted that any suitable computing device may perform the workflow 280.

Referring to FIG. 5, the process initiates at beginning block 282, from which the server system 250 proceeds to block 284 where it determines whether one or more activity sets are currently active. The server system 250 may determine that an activity set is active if it detects a lifecycle event, as described above, or receives an input of an activity set.

If an activity set is active, the server system 250 may proceed to block 286. Alternatively, if an activity set is not active, the server system 250 may proceed to block 288 and end the workflow. Referring back to block 286, the server system 250 may register the active activity set. That is, the server system 250 may initialize a script or computer-executable instructions that cause the server system 250 to initiate desired operations associated with the activity set.

Prior to executing the script, the server system may proceed to block 290 and determine whether a trigger for the activity set is dependent on another activity set. That is, in some instances, certain activity sets involve or use data acquired from the completion of other activity sets to perform its respective function. As such, each activity set may include metadata or conditions that indicate whether the initialization of the respective activity set is dependent on another activity set being completed. If the respective activity set is dependent on another activity set, the server system may proceed to block 292 and wait for dependent activity sets to complete and then proceed to block 294 and launch the respective activity set or the script associated with the respective activity set. If the other activity sets, however, are not completed, the server system 250 may proceed block 296 and verify that the trigger condition for engaging the respective activity set is met. If the conditions are confirmed, the server system 250 may proceed to block 294 and launch the respective activity set. Otherwise, the server system 250 may proceed to block 298 and wait a certain amount of time to reevaluate the trigger condition. After a timer indicates that the certain amount of time has expired, the server system 250 may return to block 296.

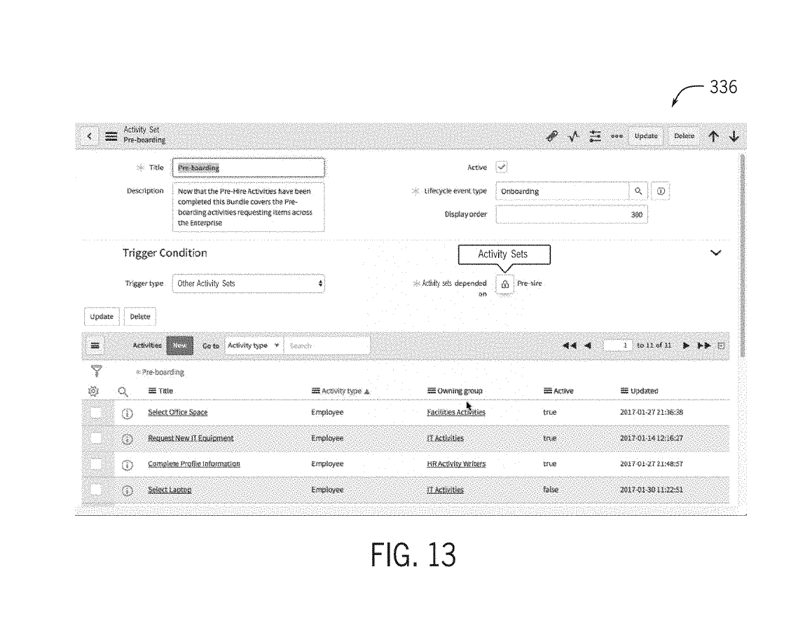

The dependent activity may be related to tasks performed by other members, tasks within an activity set, and the like. Generally, the trigger for the activity set or a task within the activity set may be associated with a time value or another activity. The trigger may be defined via a user interface as will be discussed below with reference to FIGS. 13-15.

After the activity set is launched at block 294, the server system 250 may confirm whether all activity sets have been completed at block 300. If all of the activity sets have been completed, the server system 250 may proceed to block 302 and close the script associated with the activity set. Alternatively, the server system may proceed to either block 304 and wait for an activity record related to the activity set to be updated and again check to see whether all of the activity sets have been completed at block 306. If all of the activities are still not completed, the server system 250 may return to block 304. Otherwise, the server system may proceed to block 302.

In some embodiments, if all of the activity sets are not complete at block 300, the server system proceeds to block 308 and wait for a certain amount of time to expire before re-checking whether all of the activity sets are complete at block 310. When the activity sets are complete, the server system 250 may proceed to block 302 to close the registration of the script that engaged the activity set and proceed to block 288 to end the workflow 280. If after some elapsed time or at the approach or passage of a defined critical time or date the activity sets remain uncompleted, a notification or warning may be generated to prompt attention.

It should be understood that the workflow 280 is provided as merely an example of how the server system 250 may be designed to perform the various embodiments, including the method 260, described herein. However, any suitable workflow may be implemented by the server system 250.

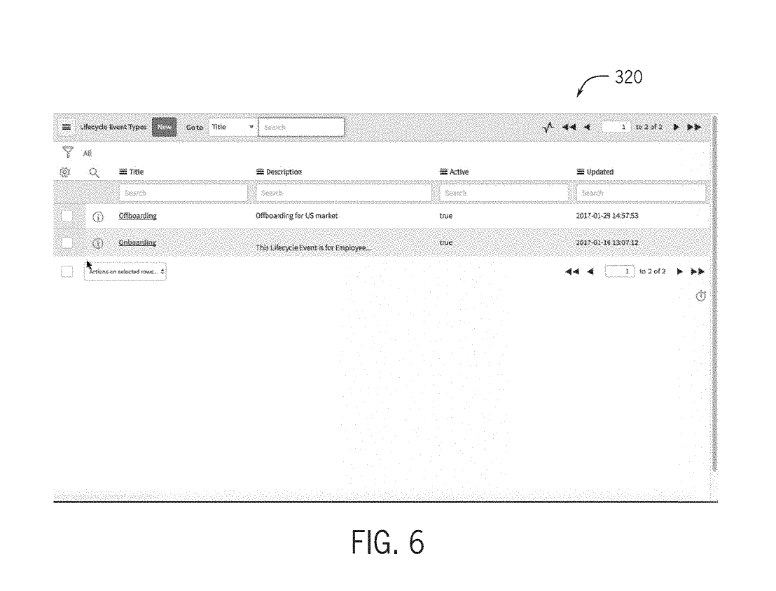

With the foregoing in mind, FIG. 6-16 provide example illustrations with regard to performing the method 260 or the workflow 280 described above. For example, FIG. 6 illustrates a user interface display 320 for a member to set up or define a lifecycle event that may cause the server system 250 to initiate the method 260. As shown in FIG. 6, the two example events are listed: off-boarding and on-boarding. The user interface display 320 may include a title field for the event, a description field to describe the event, a status field to indicate whether the event is actively detected by the server system, and a date field indicated of the date in which the event was last updated.

Each lifecycle event listed in the user interface display 320 may expanded to illustrate certain activity sets associated with a respective event. That is, the server system 250 may generate the user interface mentioned above, such that a member may view the activity sets associated with each event. In addition, the member may generate a new event and define corresponding activity sets via the user interface.

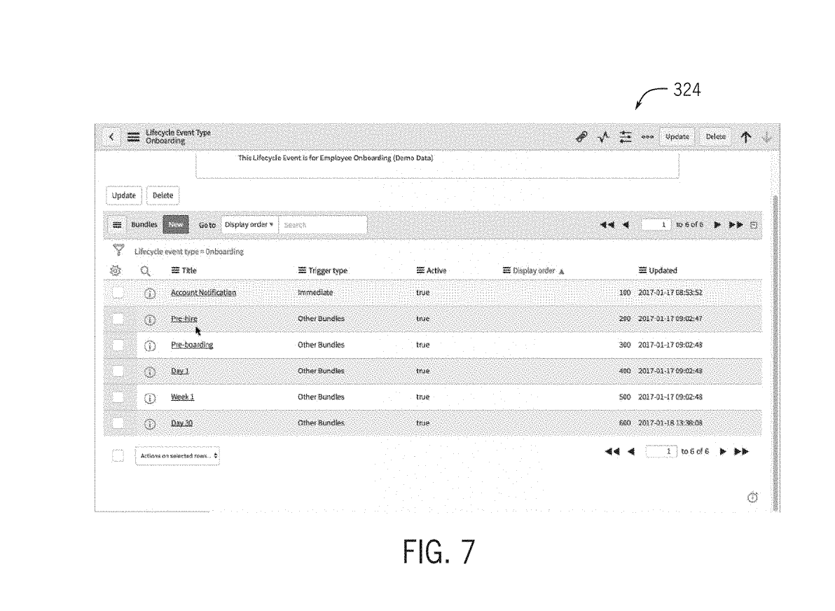

Upon selecting a lifecycle event in the user interface display 320, the server system 250 may generate a list of activity sets that are associated with the selected event. For instance, FIG. 7 illustrates a user interface display 324 that includes list of activity sets associated with the onboarding life cycle event. As shown in the user interface display 324, the activity sets may be organized with respect to a title field for the activity sets, a trigger type field that indicates how a corresponding activity set is triggered, a status field to indicate whether the activity set is active, and a date field as mentioned above.

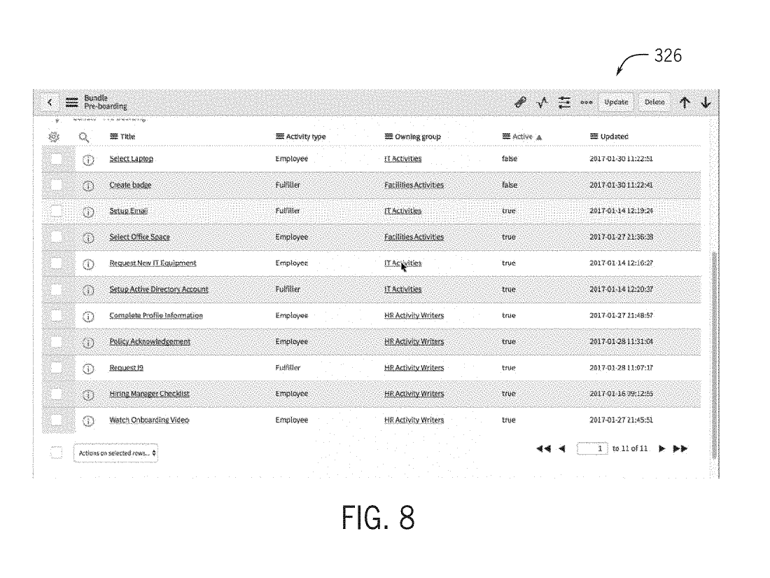

Each activity set may then be selected to display a list of activities associated with a respective activity set, as shown in the user interface display 326 of FIG. 8. The list of activities may be organized with respect to a title for the activity, an activity type field that indicates whether the activity is performed by a member (e.g., a fulfiller or an employee), an owning group that indicates a department that is responsible for the activity, a status field, and a date field. As shown in the example provided in the user interface display 326, the list of activities may be assigned to a number of different departments. By specifying to the server system 250 activities of an activity set for each of the departments that is responsible for performing the activity, the server system 250 may effectively coordinate the distribution of the activities across the various departments, employees, and fulfillers of the enterprise. In addition, the server system 250 may track the progress of each activity, and hence each activity set. Moreover, the server system 250 may store information related each activity set and activity in a database 108 accessible to the server system 250 to provide visibility to each member across the enterprise.

Upon receipt of an input associated with a particular activity listed in the user interface display 326, the server system 250 may generate a user interface display 328 that provides details regarding the activity. As shown in the user interface display 328, various details regarding the activity title, the performer of the activity, the owning department, the associated activity set, and the like may be defined or modified in via the user interface display 328.

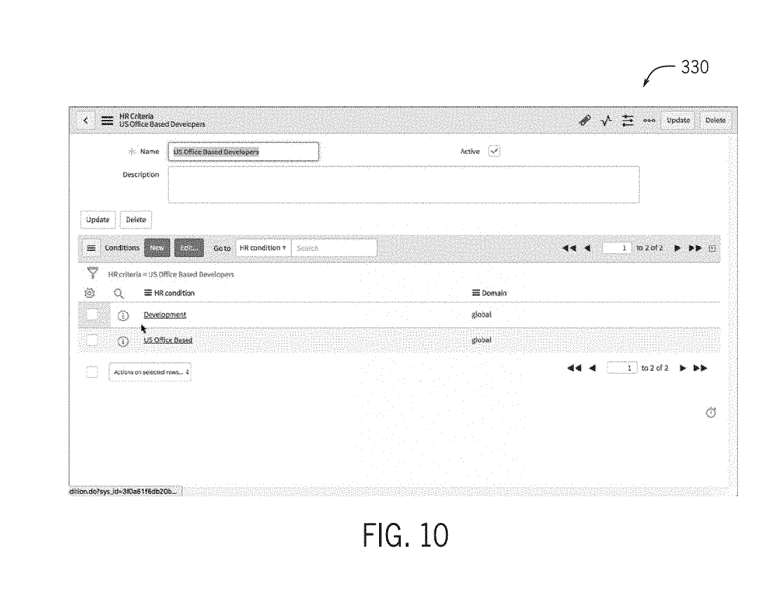

In addition, the condition or triggering data for causing the server system 250 to initiate or assign an activity set may also be specified via a user interface display, such as user interface display 330 as depicted in FIG. 10. The condition or trigger data may indicate data fields or threshold values that should be present in some entry of a database 108A to cause the server system 250 to initiate the activity set.

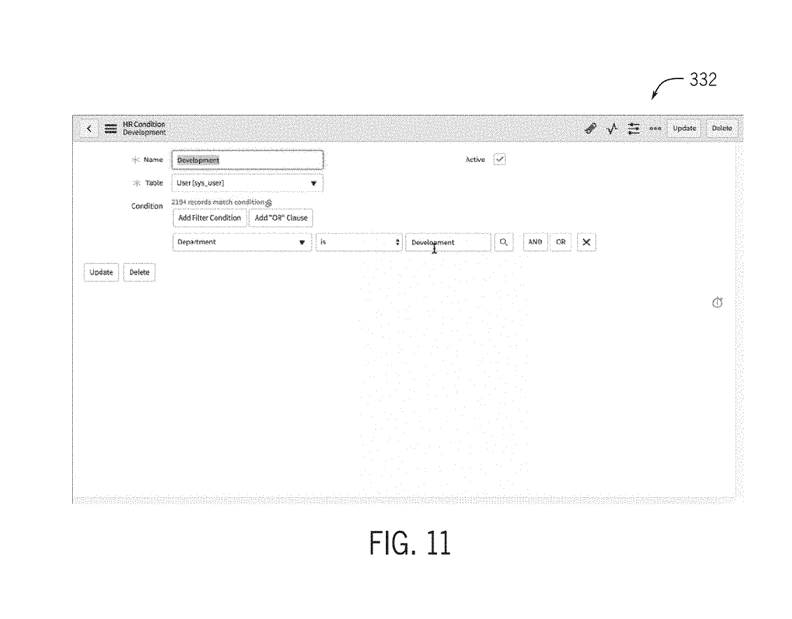

For instance, FIG. 11 illustrates a user interface display 332 that enables a member to input a condition and details that cause the condition to occur. As shown in the user interface display 332, the condition may be associated with a particular table or database 108A from which the data may be used to determine whether a condition is present. The condition may be defined using drop down menus that provides filter parameters and enables the use of Boolean logic for the condition. By way of example, the filter condition of the user interface display 332 indicates that the department of the data from the specified table should be a development department.

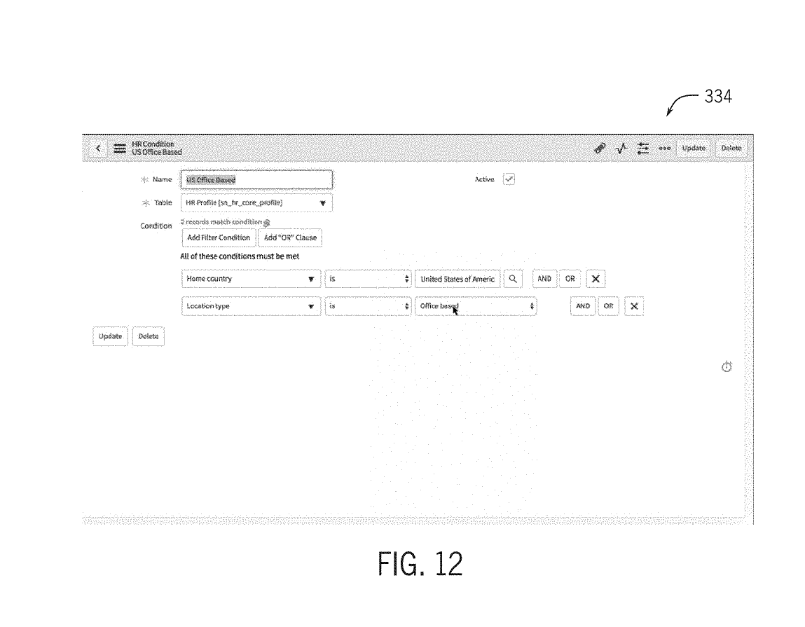

In another example of multiple condition statements, the user interface display 334 of FIG. 12 depicts how Boolean logic functions may be added to the condition statements. As shown in the user interface display 334, AND and OR Boolean operators are added between condition statements to specify the details of condition statements.

In addition to condition statements, the server system 250 may use triggers to specify when to determine whether the condition statements are met. For instance, a condition may be evaluated based on the statuses of other activity sets. For instance, the user interface display 336 of FIG. 13 illustrates an example of triggers set for a particular activity set (e.g., pre-boarding). That is, as shown in the example of FIG. 13, the pre-boarding activity set may be triggered based on data related to other activity sets, as specified in the “trigger type” field. In this manner, different activity sets may be added as triggers to define when the pre-boarding activity set should activate. For example, the pre-boarding activity set depicted in the user interface display 336 may depend on whether an office space has been selected, new IT equipment has been requested, complete profile information has been collected, and a laptop has been selected. Each of these activities may be performed by different departments, as specified in the trigger data. In the depicted example, each of the activities associated with trigger are listed as employee activity types. That is, activities may be assigned to members who may be tasked to perform activities specific to a respective department and may also be assigned to employees who may be called to reach out to various departments for different reasons. For instance, referring to the user interface display 336 the employee is tasked with selecting office space, requesting new IT equipment, completing profile information, and selecting a laptop for the facilities activities group, the IT activities group, the HR activity writers group, the IT activities group, respectively.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

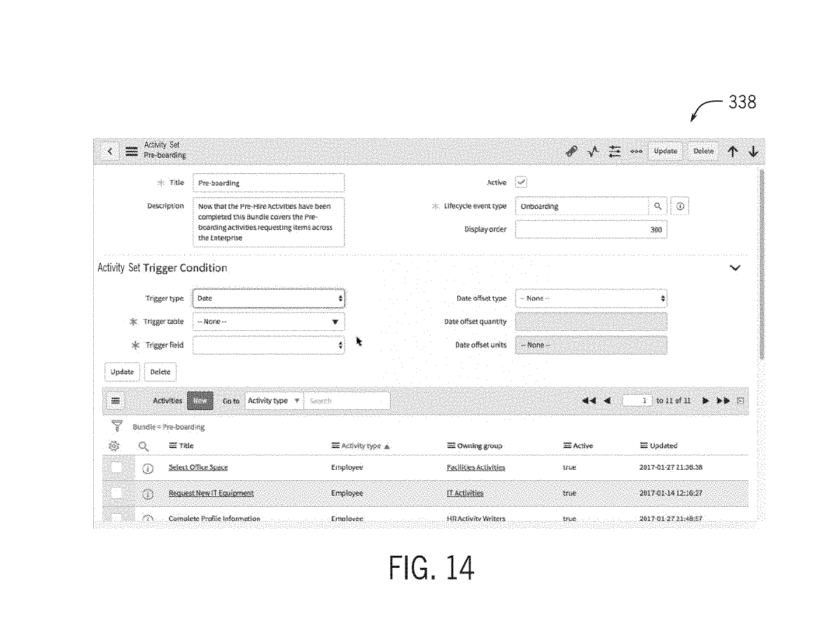

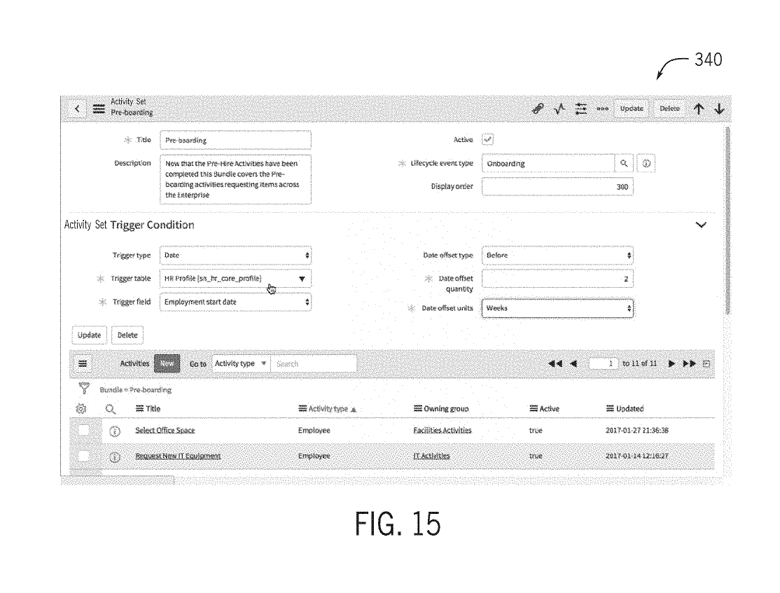

FIG. 14 illustrates a user interface display 338 that provides various fields to specify a trigger. The trigger may be established based on a trigger type (e.g., date), a table or database 108A in which the trigger data may be stored, a trigger field that specifies a type of data, a date offset type to indicate when the trigger should occur, and other date offset fields (e.g., quantity and units) to quantify the date offset field. The date-offset type may indicate whether the offset is before or after a particular date, as illustrated in the user interface display 340 of FIG. 15.

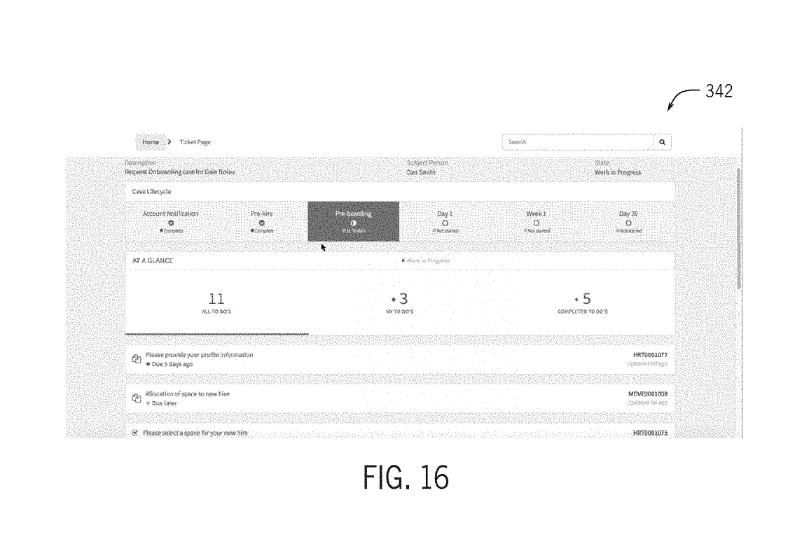

By providing a variety of user interface displays, members of an enterprise may create activity sets for members (e.g., employees or fulfillers) to perform, specify activities for the activity set, provide triggers for the activity set, generate conditions for the activity sets, and the like. In addition, the member and/or employee associated with an activity set may view assignments or status of assigned activity sets via a user display interface. For instance, FIG. 16 illustrates an example user interface display 342 that indicates a status of various activity sets for the respective member that accesses the server system 250. As shown in the user interface display 342, a case lifecycle visualization may detail various activity sets assigned to the respective member along with status information (e.g., complete, number of items to perform) organized in a timeline view. In addition, the server system 250 may provide an overview of the items to perform organized as “all to do's,” which include each item to perform in activity set regardless of who is assigned to perform the activity, “my to do's,” which refer to the items that the respective member is assigned, and “completed to do's,” which detail the activities completed.

In addition to tracking the status of activity sets assigned to a member, the user interface generated by the server system 250 may also be customized to display information targeted to the respective member. That is, announcement data, embedded video data, calendar updates, alert information, and the like may be targeted to a respective member via one or more filter parameters specified to the server system 250. In this way, information directed to specific members may be used to generate targeted visualizations and inform each respective member of the enterprise of activities and events that are relevant to the respective member. As a result, the respective member may be more likely to regularly review the information provided via the respective user interface because the information is specifically targeted to the respective member itself.

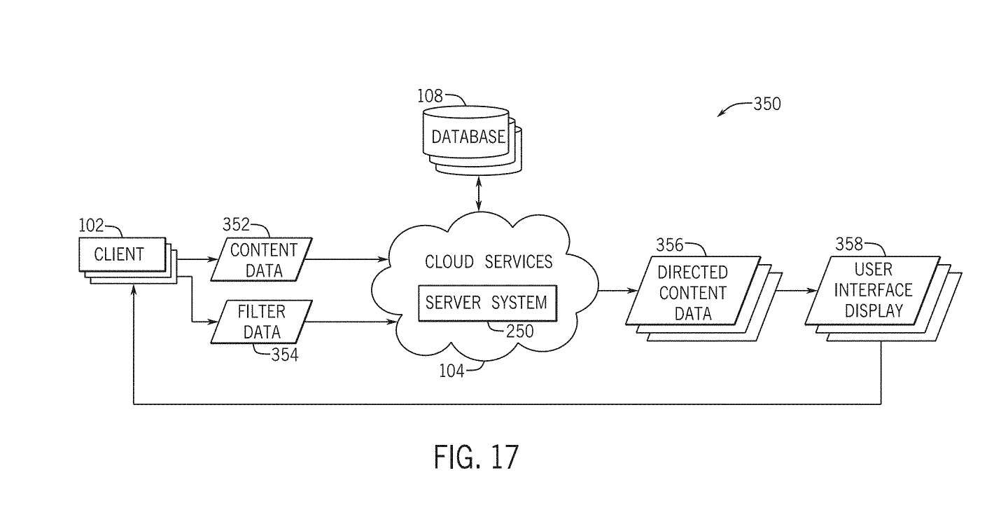

By way of example, FIG. 17 illustrates a data flow diagram of a targeted data system 350 that indicates how targeted data may be provided to a user interface display (e.g., service portal). As shown in FIG. 17, the client 102 may provide content data 352 and filter data 354 to the server system 250 via the cloud services 104. The content data 352 may include information related to events that may be of interest to a member, announcements directed at a member, calendar data associated with a member, videos that may be associated with a member, and the like. The filter data 354 may specify one or more filter parameters that identify a subset of the members of an enterprise that the content data 352 should be directed towards. The filter data 354 may include characteristics of a subset of members that may be identified via data regarding the members stored on the databases 108A. For example, the filter data 354 may include a target department of the enterprise, one or more job function/responsibilities of a member, a location of a member, one or more building names in which the member may access, equipment assigned to the member, and the like.

By providing the content data 352 and the filter data 354 to the server system 250, the server system 250 may identify the subset of members that correspond to the filter data 354 via the databases 108A. The server system 250 may then generate directed content data 356 for the subset of members identified via the filter data 354. In some embodiments, the server system 250 may use the directed content data 356 to generate user interface displays 358 for respective members of the subset of members. The user interface displays 358 may include custom visualizations arranged in an order or layout specified by the respective member, such that the user interface displays 358 may be depicted via a display of the client 102. As such, the user interface displays 358 may be pushed to the client 102 when the client 102 accesses a network or the like. In this way, the client 102 may pull or retrieve data related to the assigned activity sets and receive pushed data from other sources that intend to inform the respective member of the content data 352.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function]...”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system, comprising:
a plurality of databases associated with a plurality of departments of an enterprise, wherein each database of the plurality of databases comprises data regarding a set of members of a respective department;
a processor configured to execute computer-executable instructions which, when executed cause the processor to:
receive a lifecycle event that corresponds with an employee of the enterprise, wherein the lifecycle event is associated with a change in a status of the employee;
determine one or more activity sets based on the lifecycle event, wherein each activity set comprises one or more activities to be performed by one or more departments of the plurality of departments;
identify one or more members of the set of members to perform the one or more activities;
send one or more updates to one or more respective databases of the plurality of databases, wherein the one or more updates comprise a respective activity of the one or more activities for a respective member of the one or more members to perform; and
receive a respective confirmation when the respective activity has been performed; and
generate a visualization to be depicted on a display based on the respective confirmation, wherein the visualization is configured to track a progress of the one or more activities.

2. The system of claim 1, wherein the data comprises information regarding one or more respective job functions associated with the set of members, and wherein the processor is configured to identify the one or more members based on the one or more job functions.

3. The system of claim 1, wherein the processor is configured to:
determine trigger data associated with the one or more activity sets; and
schedule the one or more activity sets to be performed based on the trigger data.

4. The system of claim 3, wherein the visualization comprises a timeline that displays the one or more activities and one or more respective dates based on the trigger data.

5. The system of claim 1, comprising a client device configured to retrieve a user interface display comprising the visualization.

6. The system of claim 1, wherein the processor is configured to detect the one or more updates based on one or more changes in the plurality of databases.

7. The system of claim 1, wherein the lifecycle event comprises employee on-boarding, employee off-boarding, employee location change, employee department change, employee promotion, or any combination thereof.

8. A system, comprising:
a non-transitory memory;
one or more processors configured to read instructions from the non-transitory memory to perform operations comprising:
detecting an event for at least one member of an enterprise, wherein the at least one member is represented with member data stored in one or more system databases;
identifying a plurality of activity sets for a plurality of departments to perform based on the detected event;
determining a plurality of activities based on a set of criteria associated with the plurality of activities, wherein the set of criteria comprises one or more times in which the plurality of activities are to be performed, and wherein each of the plurality of activity sets comprise a portion of the plurality of activities;
generating a dynamic workflow associated with respective set of criteria for each of the plurality of activities based at least on the one or more times; and
automating the dynamic workflow to update respective set of criteria for each of the plurality of activity sets based on the one or more times.

9. The system of claim 8, wherein the plurality of activity sets is associated with trigger data that comprises an amount of time associated with initiating at least one of the plurality of activities.

10. The system of claim 8, wherein the set of criteria comprises at least one dependent activity, wherein the at least one dependent activity is completed before the plurality of activities are determined.

11. The system of claim 8, wherein the set of criteria is input via a user interface configured to be viewed on a display.

12. The system of claim 8, wherein the dynamic workflow is configured to update the at least the respective set of criteria based on previous set of criteria associated with each of the plurality of activities.

13. The system of claim 8, wherein each of the plurality of activities are to be performed by a plurality of fulfillers of the enterprise or the at least one member of the enterprise.

14. The system of claim 13, wherein the plurality of fulfillers is associated with at least two departments of the enterprise.

15. A method, comprising:
detecting, via a processor, an event that corresponds with an employee of an enterprise, wherein the event is associated with a change in a status of the employee;
determining, via the processor, one or more activity sets based on the event, wherein each activity set comprises one or more activities to be performed by one or more departments of a plurality of departments of the enterprise or to be performed by the employee;
identifying, via the processor, one or more members of the enterprise to perform the one or more activities based on data regarding the one or more members stored on a first database;
generating, via the processor, a user interface visualization for each of the one or more members, wherein the user interface visualization comprises at least one respective activity of associated with at least one of the one or more activity sets, wherein the user interface visualization for each of the one or more members is configured to be accessed by a respective computing device associated with the respective member.

16. The method of claim 15, wherein the event is detected based on a discovery of a configuration item via a network.

17. The method of claim 15, wherein the event is detected based on input received via the respective computing device.

18. The method of claim 15, comprising:
receiving, via the processor, one or more updates regarding the one or more activities, wherein the one or more updates are associated with one or more states of progress for the one or more activities; and
updating, via the processor, the user interface visualization based on the updates.

19. The method of claim 15, wherein the one or more activities is defined via a computing device associated with at least one of the one or more members.

20. The method of claim 19, comprising receiving, via the processor, data associated with the one or more activities, wherein the data comprises information regarding an operation to be performed for each activity of the one or more activities, a department of the plurality of departments assigned to each activity of the one or more activities, a set of criteria associated with each activity of the one or more activities, or any combination thereof.
